(19) United States
(12) Patent Application Publication
(10) Pub. No.: US 2006/0152721 A1
(43) Pub. Date: Jul. 13, 2006

(54) Method and device for identifying micro organisms

(76) Inventors: Mika Korkeamaki, Riihikoski (FI); Jussi Vaahtovuo, Turku (FI)

Correspondence Address: YOUNG & THOMPSON, 745 SOUTH 23RD STREET, 2ND FLOOR, ARLINGTON, VA, 22202, US

(21) Appl. No.: 10/523,935

(22) PCT Filed: Aug. 7, 2003
(86) PCT No.: PCT/FI03/00596

§ 371 Date: Oct. 14, 2005

(30) Foreign Application Priority Data
Aug. 7, 2002 (FI) 20021451

(51) Int. Cl. G01J 3/30; G01N 21/64

(52) U.S. Cl. 356/318; 250/458.1

(57) ABSTRACT

The invention relates to a method and device for identifying at least one micro organism and/or micro organism species and for measuring the portion of at least one micro organism and/or micro organism species from a sample. The method includes the use of two different fluorescent agents and the excitation with light in two different wavelengths. The sample is subjected to a flow. Furthermore, the invention relates to the use of the aforementioned method and device for identifying micro organisms and for measuring their portions.

The invention relates to a method and device for identifying one or more micro organisms and/or micro organism species, and for measuring the portion of at least one micro organism and/or micro organism species from a sample, as well as the use of the aforementioned method and the aforementioned device.

### PRIOR ART

The species-specific identification and calculation of micro organisms from a mixed micro organism sample is slow and cumbersome with the methods used at present. A mixed micro organism sample is herein used to mean a sample containing several micro organisms and micro organism species. Typical examples of mixed micro organism samples include faeces and waste water. For example, human faeces has been found to contain 300 to 400 different bacterial species, the bacterial density in the sample being of the order of 10¹¹ bacterial cells per gram of the sample (Human fecal flora: the normal flora 20 Japanese-Hawaiians; W. E. C. Moore and L. V. Holdeman, Applied Microbiology, 1974, vol. 27, p. 961-979). The most applicable method at present for e.g. identifying and calculating bacterial species from a mixed bacterial sample is microscopy-FISH utilising fluorescence microscopy (Extensive set of 16S rRNA-based probes for detection of bacteria in human feces; H. J. M. Harmsen et al., Applied and Environmental Microbiology, 2002, vol. 68, p. 2982-2990). The abbreviation FISH comes from the words fluorescence In Situ Hybridization. FISH is a generally used molecular biological technique in which a sequence-specific probe is attached to i.e. hybridized into the nucleic acid sequence of the cell being identified. A probe is a short nucleic acid sequence having a determined basic order that as being introduced into the cell adheres to the complementary bases of its own. The specificity of the probe is based on the compatibility of the basic sequence of the probe and that of the complementary basic sequence. As the target sequences of the probes to be used in a bacteriological FISH techniques function the nucleic acids of the 16S rRNA or 23S rRNA structural units of the ribosomes of bacteria. In the hybridization, the probe binds to the sequence of the target cell only in case the bases forming the sequence of the 16S rRNA or 23S rRNA of the probe and of the target cell are compatible. The gene areas encoding the 16S rRNA and 23S rRNA molecules have remained almost changeless as the evolution has developed. The genes in question and the structure of the ribosomes are similar in respect of their sequence for those kind of bacterial species that are close as concerns their evolution history. Probes binding to the 16S or 23S rRNA can, due to this, be prepared so as to be such that they only bind to the 16S rRNA or 23S rRNA nucleic acid sequences of some bacterial groups being related to each other (Phylogenetic identification and in situ detection of individual microbial cells without cultivation; R. I. Amann et al., Microbiological Reviews, 1995, vol. 59, p. 143-169). Thus, e.g. a probe specific for the genus bifidobacterium can be created. In the 16S rRNA hybridization, in one bacterial cell, there are from hundred to several thousand pieces of 16S rRNA molecules suitable for the sequence of the probe, so when the number of probes is sufficient, there are hundreds or thousands of probes binding to one bacterial cell.

In the FISH technique, the identification of a hybridized bacterium is based on the fact that attached to the probe is a fluorescent molecule, i.e. a fluorochrome. Fluorochromes are excited as they absorb energy at the wavelengths of an absorbance spectrum characteristic of them. The creation of the excited state requires that the electron(s) of the fluorochrome molecule absorbs i.e. receives an energy quant and moves over to the outer electron shell. As the excited state discharges, the electron emits i.e. produces the energy quant and collapses back to its basic state. In the absorbance spectrum of each fluorochrome there is an absorption maximum, i.e. a wavelength that the fluorochrome absorbs the most. As the excited state discharges, the fluorochromes emit photons of a longer wavelength than the excited wavelength, i.e. they fluoresce. Also the wavelengths of the emitted light form a distribution i.e. an emission spectrum. The emission maximum of the emission spectrum is the wavelength that the fluorochrome emits the most. The difference between the absorption and emission maxima is called the Stokes shift. A typical fluorochrome used in the FISH method is fluorescaine, the absorption maximum of which is 494 nm, emission maximum 520 nm and the Stokes shift thus 26 nm. (Handbook of Fluorescent Probes and Research Products, Molecular Probes). For historical reasons, fluorescaine is the most used fluorochrome, and it is generally used as a reference fluorochrome. The disadvantages of the use include a relatively rapid decreasing of intensity (photobleaching), which renders difficult the calculation of the bacteria in the microscopy-FISH method. In addition, the pH sensitiveness of the intensity of the light emitted by the fluorescaine makes it difficult to use it in many applications, and slows down the production of reagents. Fluorescaine also has a wide emission spectrum, which makes it difficult to use it in applications utilising several fluorochromes. Usually in the microscopy FISH method, the sample is illuminated with a source of light having a wide wavelength spectrum, in which case the labels bound to the probes are excited and emit light in the relation of the wavelengths of their emission spectrum. When the sample is scrutinised by means of a fluorescence microscope to be used in the microscopy FISH through a suitable wavelength filter, solely the hybridized bacteria are visible as emitting particles, i.e. as light-coloured dots in the dark microscope field.

Combined with the FISH technique is generally DNA staining for calculating all the bacteria i.e. the total number of bacteria in a sample. Natural mixed bacterial samples contain in addition to bacteria always also material of non-bacterial origin. Examples of these include fibres of faeces and non-organic materials of waste waters. The DNA colours to be used are generally fluorochromes intercalating into the double helix of DNA, the intensity of which fluorochromes grows many times as a result of binding. Examples of DNA colours include propidium iodide and etidium iodide. The DNA colours also bind to the hybridized bacteria. In order to be able to distinguish the bacteria hybridized with the probe from among all the DNA stained bacteria as being of a different colour, the emission spectrum of the DNA colour has to differ from the emission spectrum of the fluorochrome attached to the probe. Often also the absorption spectrum of a DNA colour differs from the absorption spectrum of the colour of the probe. By using DNA staining in conjunction with FISH it is possible to distinguish the hybridized and DNA stained target bacteria from the rest of the bacteria of the sample just DNA stained and from DNA non-stained particles not containing DNA.

In the microscopy-FISH method, the hybridized mixed bacterial sample is scrutinized with a fluorescence microscope. In this method, a sample attached to a microscope slide is illuminated with a source of light having a wide wavelength spectrum, in which case the fluorochromes in the sample absorb energy and emit light according to the wavelength distribution of their emission spectrum. The scrutinizing of the sample happens through the optical components filtering the different wavelengths of the light reflected from the sample. To calculate the number of hybridized bacteria, a filter is used that only passes through the light emitted by the fluorochrome of the probe. To calculate the total number of bacteria, a filter is used that only passes through the light emitted by the DNA colour. By knowing the number of target bacteria of the sample and the number of total bacteria, the portion of the target bacteria can be calculated.

Disadvantages of the microscopy-FISH method involve slowness and interpretative nature of results due to the non-specific hybridization. In a non-specific hybridization, the probe to be hybridized attaches to the nucleic acids of other than those of the actual target bacteria, and even to the surface structures of bacteria. The number of probes non-specifically hybridized into the bacterium is usually less than the number of probes in the actual hybridized target bacteria, but even a small number of probes causes the bacterium to be seen lighter than its background. This causes difficulty of interpretation in the microscopy-FISH. A person very well familiar with the method is able to calculate up to some thousands of bacterial cells per hour. From the huge amount of bacteria contained in mixed bacterial samples it is possible to calculate a very small part, with reasonable use of time, so the number of samples remains small (Phylogenetic identification and in situ detection of individual microbial cells without cultivation; R. I. Amann et al., Microbiological Reviews, 1995, vol. 59, pp. 143-169). Due to these reasons, the repeatability of the results obtained by the ‘microscopy-FISH method often’ remains unsatisfactory.

Due to the disadvantages associated with the microscopy-FISH, there has been an attempt to develop more rapid and dependable methods instead of it. As one alternative solution, there has been presented a method in which attached to the microscope oculars is a video or digital camera. The images taken with the camera have been analyzed using a computerized image processing program which identifies from each image particles brighter than the adjusted luminance limit and classifies these as bacteria to be examined (Automatic signal classification in fluorescence in situ hybridization images; B. Lerner et al., Cytometry, 2001, vol. 43, p. 87-93). Using this method, the analyse velocity can be improved a little, but the analysing of the sample is nevertheless rather slow. As in a manual microscopy-FISH, the problem with the automated microscopy-FISH is the determination of the luminance limit to be identified and the distinguishing of the non-specifically hybridized bacteria from the hybridized target bacteria. The automated microscopy-FISH has not spread into wide use.

Flow cytometry is a method used for decades that enables a fast analysis and calculation of particles in a liquid. Many particles can be suspended into a solution. By means of the flow cytometry it is possible to measure several parameters simultaneously from the particles of a sample. Flow cytometry is used in various clinical and industrial applications, particularly in the field of biomedicine. Flow cytometry is at present the most important qualitative identification and calculation method of liquid eukaryotic cell samples. Among other things, leucocytes in human blood are routinely scrutinized by automated flow cytometers. Instead, flow cytometric analysis methods of prokaryotic cells i.e. bacteria have not spread into wide use. The level of technique of flow cytometry equipment and the level of know-how of flow cytometry have been an obstacle to becoming general of bacteriological analysis and calculation methods based on flow cytometry, the level not allowing a dependable analysis of prokaryotic cells considerably smaller than the eukaryotic cells. During the last ten years, with the development of flow cytometric equipment, there have been published, however, methods for analysing bacteria based on flow cytometry (Flow cytometry and cell sorting of heterogeneous microbial populations: the importance of single-cell analyses; H. M. Davey and D. B. Kell, Microbiological Reviews, 1996, vol. 60, p. 641-696). The methods known at present are not suitable for routine use and they cannot be used to calculate the micro organism concentrations of mixed micro organism samples. Also the samples analyzed were not mixed micro organism samples akin to faeces unknown as their gamut of species is concerned. The presented methods are not based on simultaneous use of flow cytometry and fluorescent hybridization probes (e.g. publications US 2002/076,743, U.S. Pat. No. 6,165,740, DE 19608320, DE 19945553, EP 337 189). In scientific articles one has focused mainly on the analysis of pure culture samples containing one bacterium species, examined the interactions of bacteria and leucocytes in blood, metabolic processes and growth of bacteria as well as separated living bacteria from dead ones (Analysis of bacterial function by multi-colour fluoresencece flow cytometry and single cell sorting; G. Nebe-von-Caron et. al., Journal of Microbial methods, 2000, vol. 42, p. 97-114). One has tried to examine mixed bacterial samples by means of flow cytometry using antibodies attaching to bacteria (Multiparameter flow cytometry of bacteria: implications for diagnostics and therapeutics; H. M. Shapiro, Cytometry, 2001, vol. 43, pp. 223-226, and Detection of plant pathogenic bacterium Xanthomas campestris pv., Campestris in seed extracts of Brassica sp. applying fluorescent antibodies and flow cytometry; L. G. Chitarra et al., Cytometry, 2002, vol. 47, p. 118-126, and U.S. Pat. No. 6,225,046 of D. Vail, and patent EP0347039 of L. Terstappen. The methods based on the use of antibodies, have, however, not enabled a dependable species-specific examination of mixed bacterial samples, since antibodies are not bacterium species-specific. Antibodies attach to the surface structures of bacteria that are not species or genus-specific, and they can bind to various species of bacteria. Same surface structures can be found in very different bacteria, and on the other hand bacteria of the same strain may have very different surface molecules (What determines arthritogenicity of a bacterial cell wall?; X. Zhang, doctoral thesis, 2001 University of Turku).

The main components of a flow cytometer include a pressurized sample feeding system, a laser and signal identification equipment. The data on the particles to be examined obtained using the flow cytometer is analysed by a computer connected to the flow cytometer. The pressurized sample feeding system of the flow cytometer pumps the sample to be examined into a sample feeding needle. From a hole at the head of the needle the sample flows into a flow chamber that contains shell fluid. As the shell fluid, a liquid similar to the sample solution in respect of its optical properties is used. The shell fluid surrounding the thin flow of sample solution from the sample feeding needle forces the particles in the flow of sample solution apart from each other to form a uniform line. The event is called hydrodynamic focusing. The line of particles has been aligned with the laser included in the flow cytometer in such a manner that the laser beam meets the particles at a right angle. In addition to the sample feeding equipment and laser, a third important hardware component of the flow cytometer is signal identification equipment. The particles in the sample to be examined cause scattering of the laser beam. The scattering of the laser beam in the direction of motion of the laser at small angles is identified by a photodiode against the incoming direction of the laser. The size of the scattering angle is measured as a Forward Scatter parameter (FSC). The scattering of the laser at bigger angles in respect of its direction of motion is measured as a Side Scatter parameter (SSC) by a photo multiplier tube. The FSC roughly correlates with the size of the particles to be identified in such a manner that big particles that touched the laser beam scatter the laser beam more than small ones. The SSC parameter correlates with the shape and graininess of the particle. In addition to the SSC and FSC detectors, the signal identifying equipment includes photo multiplier tubes for identifying the fluorescence from the sample. The high energy photons of the laser excite the fluorescent agents such as fluorochromes in the particles to be examined. As the excited state of fluorochromes discharges, they emit light according to their emission spectra. The fluorescence is measured by photo multiplier tubes identifying a suitable wavelength. The fluorescence detectors are disposed with respect to the laser generally in the same direction as the SSC detector. The emitted light is registered by photo multiplier tubes identifying a suitable wavelength at a right angle with respect to the incoming directions of the laser and fluid flow. In the most common flow cytometers, fluorescence is identified by four photo multiplier tubes, whose abbreviations are correspondingly FL1, FL2, FL3 and FL4. The wavelength filters disposed on the illuminating train of the FL detectors are each used to identify solely a determined wavelength area. To distinguish the particles to be examined from the background noise of the equipment and from the impurities of the sample solution it is possible to determine a threshold value for one or more scattering or fluorescence channels. In case the particle causes on the channel (channels) in question a signal exceeding the threshold value, the electronics of the flow cytometer measure the parameters of the particle in question. In case the signal caused by the particle on the threshold value channel is less than the threshold value, the parameters of the particles remain unmeasured. The threshold values should be set so that there will be no particles to be examined remaining unmeasured, i.e. the sample to be analyzed is representative and not distorted. The measuring signals gathered from different detectors of the flow cytometer are introduced into the signal processing equipment, and the obtained data is analysed by means of a computer software program. The particles contained in the sample to be examined are most generally presented in a two-dimensional dot diagram, in which on both axes there is one of the identifying parameters: FSC, SSC, or one of the fluorescence channels. The identified particles are presented in the diagram as dots, in which case particles of the same type form groups of dots, i.e. populations. When using the dot diagram it is possible to analyse from the sample only two variables at a time. In case there is a wish to sort out populations based on more than two variables, the analysis must be performed in more than just one dot diagram.

A considerable difference between the FISH applications based on microscopy and flow cytometry is the dissimilarity of the light sources used for the exciting of the fluorescent agents such as fluorochromes in the sample. In microscopy-FISH, the sample is illuminated with a wide spectrum light that is capable of exciting fluorochromes having various exciting wavelengths at the same time. By changing the wavelength filter, it is possible each time to calculate from the same sample the micro organism population containing the desired fluorochrome. In flow cytometry, the exciting of the fluorochromes is often performed with a laser containing one wavelength. In case a flow cytometer equipped with one laser is used to examine one or more fluorochromes simultaneously, the fluorochromes being used must be such that they are excited at the same wavelength but their emissions differ from each other so that each population can be identified by their own FL detector. The use of such fluorochrome combinations is general in the analysis of eukaryotic cell samples, but no fluorochrome combinations suitable for the FISH technique are known (Handbook of Fluorescent Probes and Research Products, Molecular Probes). In practice this has meant that using the flow cytometry-FISH it has not been possible to distinguish and calculate the target population hybridized with the probe and DNA stained from solely a DNA stained population containing the other micro organisms of the sample as well as from the background population formed by the particles of non micro organism origin in the same analysis.

In the flow cytometry-FISH methods heretofore, applicable for research use only, the distinguishing of a 16S rRNA hybridized target population from the rest of the bacteria of the sample and from the background population has been based on several non-simultaneous analyses as well as on the use of parameters other than the fluorescence parameters. It has not been possible to calculate the number of micro organism cells contained in the sample and the portion of the hybridized target micro organisms in the same analysis. To increase the differences in fluorescence, in the best flow cytometry-FISH method thus far, the target bacteria have been hybridized with two different probes (Quantification of uncultured Ruminococcus obeum-like bacteria in human fecal samples with fluorescent in situ hybridization and flow cytometry using 16S rRNA targeted probes, E. G. Zoetendal et al., in the doctoral thesis Molecular characterization of bacterial communities in the human gastrointestinal tract, 2001, E. G. Zoetendal, University of Wageningen, Holland). The probes have been labelled with different fluorochromes, which are seen on different fluorescence channels. The exciting and emission wavelength spectra of the fluorochromes of the probes are so far from each other that the exciting of the fluorochromes with just one laser is not successful, instead one must use two lasers having different wavelengths, the beams of which hit the particles of the sample at different times. In this method, both lasers must be used to distinguish the target population from the rest of the bacteria of the sample. In the same manner, both axes of the dot diagram are used to distinguish the target population from the rest of the bacteria of the sample, and it is not possible to distinguish the total bacterial population from the background population at the same time. To calculate the total number of bacteria, one must perform another analysis in which the sample is not hybridized but just DNA stained. In the method of Zoetendal, also the distinguishing of the target population from the rest of the bacteria remains weak. e.g. due to the weak intensity of the fluorochromes used in the method and due to the big background.

In another alternative embodiment in use, the target population has been hybridized with one probe having one fluorochrome (Flow cytometric analysis of activated sludge with rRNA-targeted probes; G. Wallner et al., Applied and Environmental Microbiology, 1995, vol. 61, p. 1859-1866). To distinguish particles containing DNA from particles not containing DNA, the hybridized sample has been stained with a DNA colour that cannot be excited with the same laser as the fluorochrome of the probe, so two lasers are used also in this method. Wallner's objective was herein the simultaneous detection of the target bacterial population, of the rest of the bacteria contained in the sample and of the background population in the same diagram. As the DNA colour, Wallner chose the fluorochrome absorbing and emitting the light of the ultraviolet wavelength area (Hoechst Blue, Molecular Probes), and the flurochrome attached to the probe was a fluorescaine of the bluish-green wavelength area. Although one has used in the method very strong and expensive water-cooled lasers having the power of hundreds of milliwatts, the intensity of the fluorochromes used remains weak, and the population cannot be satisfactorily distinguished from each other in one analysis. To distinguish the DNA stained particles from. DNA non-stained particles, Wallner has to use an additional application program that leaves the non-stained particles totally outside the analysis, and the DNA stained and DNA non-stained particles cannot be described in the same dot diagram. This weakens the dependability of the method. Wallner does not either calculate the concentrations of the bacteria per unit of volume, instead only the proportions of the bacterial species.

The third flow cytometric method presented in scientific publications for analysing 16S rRNA hybridised mixed bacterial samples is based on the use of one laser and a DNA colour suitable for it and of a fluorochrome attached to the probe (Combination of 16S rRNA-targeted oligonucleotide probes with flow cytometry for analyzing mixed microbial populations; R. Amann et al., Applied and Environmental Microbiology, 1990, vol. 56, pp. 1919-1925). Also in this method, the low intensity of the fluorescence of the fluorochromes used in the probes does not make it possible to distinguish the target bacteria i.e. the bacteria to be analysed from the rest of the bacteria contained in the sample. The absorption maximum of the DNA colour used is at the same wavelength as the emission maximum of the fluorochrome of the probe. The probe's fluorochrome used to distinguish the target bacteria from the rest of the bacteria in the sample uses its emission energy to excite the DNA colour, and the fluorescence of the target bacteria is not sufficient for their dependable distinguishing from the rest of the bacteria in the sample. In case the DNA colour and the probe labelled with the fluorochrome are bound close enough to each other, the energy transfer between them may also happen as an energy transfer between molecules without photons e.g. as a FRET (Fluorescence Resonance Energy Transfer) phenomenon (Use of phycoerythrin and allophycocyanin for fluorescence resonance energy transfer analyzed by flow cytometry: Advantages and limitations; P. Batard Cytometry, 2002, vol. 48, pp. 97-105). The target bacterial population and the population formed by the rest of the bacteria in the sample are overlapping in the dot diagram, and it is not possible to calculate the number of bacterial cells and the portion of the target bacteria from the total number of bacteria.

As was presented above, in the methods of Zoetendal, Wallner and Amman, all the three populations: target bacteria, the rest of the bacteria in the sample and the DNA-non-stained particles cannot be dependably distinguished. The concentration of bacteria and the portion of target bacteria in the sample cannot be dependably calculated. Thus, these methods are not applicable for the calculation of concentrations of bacteria contained in complicated mixed bacterial samples such as faeces, as well as for the specific and dependable identification and calculation of separate bacterial species. As a results of this, the flow cytometric analyses of mixed bacteria have been unreliable, and the microscopy-FISH is still the only method to be reckoned for the species-specific identification and calculation of the bacteria contained in mixed bacterial samples.

Thus, the objective of the invention is to achieve a method and device by means of which it is possible to analyse a mixed micro organism sample, to identify the micro organisms and/or micro organism species contained in it as well as to measure their portions in the sample. Another objective of the invention is to achieve a method and device by means of which it is possible to measure also the concentrations of micro organisms and/or micro organism species in the sample. Yet another objective of the invention is to achieve a method of this kind that would be fast, inexpensive and dependable.

### DESCRIPTION OF THE INVENTION

The objectives referred to above have been attained by the method and device of the invention.

The invention relates to a method and device for identifying one or more micro organisms and/or micro organism species and for measuring the portion of at least one micro organism and/or micro organism species from the sample. The invention also relates to the use of the method and device in accordance with the invention for the identification of micro organisms and the measuring of their portions.

The sample may be e.g. a sample taken from the organism of a mammal, a waste water sample or any other sample that contains particles such as one or more micro organisms or micro organism species and/or material of non-micro organism origin. Examples of material of non-micro organism origin include fibres, non-organic material, impurities and other units scattering and/or fluorescing light. The micro organism may be e.g. bacteria, protozoa, funguses or viruses. Characteristic of the invention is what has been presented in the appended claims.

In the method according to the invention:
a) binding to a structure individualising least one micro organism species or group and enabling the identification a first fluorescent agent which absorbs light in a first wavelength area,
b) binding to a structure characteristic of all the micro organisms a second fluorescent agent which absorbs light in a second wavelength area,
c) subjecting the sample to flow,
d) exciting the said first fluorescent agent in the said flow with a monochromatic light disposed in the first wavelength area,
e) exciting the said second fluorescent agent in the said flow with a monochromatic light disposed in second wavelength area,
f) identifying the target micro organism by analysing the fluorescence of the fluorescent agents bound to the particles,
   and in that the fluorescent agents and the wavelengths of the monochromatic light are chosen in such a manner that a measurable difference in intensities between the fluorescences of the fluorescent agents is achieved.
   The device according to the invention comprises:
a) a flow chamber (5), into which a solution to be analysed (6) containing the sample is introduced, in which solution to the structure enabling the identification and individualising at least one micro organism species or group, a first fluorescent agent is bound that absorbs light in the first wavelength area, and in which to the structure characteristic of all the micro organisms, a second fluorescent agent is bound that absorbs light in the second wavelength area,
b) a light source (1, 3) for producing a monochromatic light at different wavelengths,
c) one or more detectors (14, 15, 16, 17) for measuring the signal forming the fluorescent agent for identifying the target micro organism,
   and in which device the fluorescent agents of the sample and the wavelengths of the monochromatic light have been chosen in such a manner that a measurable difference in intensities between the fluorescences of the fluorescent agents can be achieved.

Further, the method and device according to the invention can comprise a step and correspondingly means for calculating the portion(s) of the identified target micro organism(s) from the total amount of sample.

The measurable difference in intensities to be achieved by means of the method and device of the invention can be e.g. at least about double on a logarithmic scale, and advantageously about quadruple on a logarithmic scale.

In one embodiment of the invention, a first fluorescent agent such as e.g. a fluorochrome is attached to probes that are bound to a structure enabling the identification and individualising at least one micro organism species or group. The structure in question can be any unit characteristic of a certain micro organism species or group by means of which it is possible to identify the aforementioned species or group from other micro organisms. The characteristic structure can be e.g. a part of the DNA or RNA and/or some other structure characteristic of a certain micro organism species or group. The characteristic structure is advantageously a 16S ribosomal RNA molecule and/or a 23S ribosomal RNA molecule.

In the embodiment of the invention presented above, a second fluorescent agent such as e.g. a fluorochrome is bound to a structure characteristic of all the micro organisms. A structure characteristic of all micro organisms can be any structure typical of them that enables the distinguishing of the micro organisms in the sample. The characteristic structure is advantageously DNA.

The device in accordance with the present invention can be any device enabling the identification of the particles in the sample and enabling the measuring of their portion. According to one embodiment of the invention, the device is a flow cytometer.

The method and device in accordance with the present invention enables one to solve the problems described above. The method in accordance with the invention for species-specific identification of micro organisms and for measuring their portion from a mixed bacterial sample considerably differs from previously described methods in that the distinguishing of the target micro organisms, the rest of the micro organisms in the sample and the background population, as well as the calculation of the accurate number of the micro organism cells contained in the sample and the portion of the target micro organisms is possible with one analysis.

The substantial difference to the method of Zoetendal that uses two lasers is in that in the method of Zoetendal, both lasers are used to excite the flurochromes i.e. distinguish the target bacteria from the rest of the bacteria in the sample, and the DNA stained total population of bacteria cannot be distinguished from the background population in the same analysis. The threshold value of the particles to be analysed has been adjusted for the FSC parameter in the method of Zoetendal. This has lead into a distortion of the sample because a big part of the bacterial cells have had an FSC value less than the adjusted threshold value. The weak sample can be seen in the figures of Zoetendal's publication. The use of two different analyses and samples substantially weakens the reliability of the results. The use of two probes adds to the costs and for its part also weakens the reliability of the method, since the probes do not necessarily hybridise the same bacterial species. In the Zoetendal's method one cannot either show that the probes would be really bound to the particles containing DNA, since the DNA stained and hybridised particles are examined based on different samples.

The substantial difference compared to Wallner's method is e.g. in that Wallner uses as the DNA colour the fluorochrome of the UV wavelength area and in the hybridisation probe the fluorochrome of the bluish-green wavelength area. The fluorochromes used by Wallner have such a low intensity that the different populations of the sample cannot be dependably distinguished. Wallner uses as the threshold value the SSC parameter, which causes a distortion of the sample. Wallner eliminates the DNA non-stained particles from the analyses by means of a computer software program, which results in an additional distortion of the sample. Because of his arrangements concerning the method, Wallner uses high-powered and costly water-cooled argon-ion lasers of hundreds of milliwatts, but the target bacteria cannot be distinguished from the rest of the bacteria of the sample anyway. In Wallner's publication, as the mixed bacterial sample, an active sludge to be used in water purification is used, which active sludge is an artificial mixed bacterial sample. The bacteria contained in an active sludge contain more rRNA than bacteria in natural state, so the sample used by Wallner cannot be compared to a complicated ecosystem like the intestinal bacterial flora. Wallner himself states in his article that his method does not function in the examination of mixed bacterial samples more complicated than the active sludge, such as faeces.

In Amann's method, the sample is an artificial mixture made of cultured bacteria. The hybridised target bacterial population, the total bacterial population and the background populations cannot be distinguished in the same analysis, so also the method of Amann is basically different compared to the method now described. In addition, Amann needs in his method a high-powered, costly laser.

A considerable advantage by the method and device of this patent application is gained in that it enables a dependable, simultaneous distinguishing of all the three populations: the target micro organism population, the population formed by the rest of the micro organisms in the sample and the background population. This makes the analysis of the samples faster and makes the species-specific identification and calculation of micro organisms contained in mixed bacterial organism samples more dependable than before and enables a fast clarification of the concentration of micro organisms in a sample.

In the method according the invention, the hybridised probes can really be proven to be in the micro organisms and not e.g. in the particles of the background population, since the hybridised particles can be detected as being DNA stained in the same analysis and dot diagram. By using (e.g. by means of a hybridisation probe) as the bound fluorochrome, a fluorochrome sufficiently absorbing and emitting the light of the red wavelength area, and as the fluorochrome (e.g. a DNA colour) bound to all the micro organisms being examined, a fluorochrome sufficiently absorbing and emitting the light of the orange or a shorter wavelength area, there will be no hindering energy transfer between the fluorochromes. If the fluorochromes were used in such a manner that to the hybridisation probe, a fluorochrome absorbing and emitting the light of the shorter wavelength area would be attached and as the DNA colour, a fluorochrome absorbing and emitting the light of the longer wavelength area would be used, there could be an energy transfer between the fluorochromes hindering the distinguishing of the target micro organisms from the rest of the micro organisms in the sample.

As a method being both fast, automatic, and capable of being automated, the analysis of the micro organisms hybridised with the FISH technique according to the invention is a considerably better method than the microscopy-FISH for the species-specific examination and calculation of complicated mixed bacterial micro organism samples. The device according to the invention enables one to dependably identify even thousands of particles per second. In a unit of time, the number of identified micro organisms is thus multiple as compared to microscopy. The information given by a device correctly enabled is unambiguous, which reduces the error caused by human factors. The method according to the invention also enables one to count the number of the micro organisms contained in the sample more accurately and faster than by other methods.

The measuring of the portion of a micro organism and/or micro organism species is used to mean the measuring of a proportional or absolute portion. The mean fluorescence intensity is calculated either in an arithmetic or geometric manner. Advantageously, the geometric mean value is used. It is obvious for a person skilled in the art that in case the distribution substantially follows the Gaussian curve, the same result is obtained both ways, but in case this is not the case, using the geometric means, a more representative result is obtained.

As was mentioned above, in one embodiment of the invention, a first fluorescent agent such as e.g. a fluorochrome is attached to the probe, which is bound to a structure enabling an individualising identification. The binding of the probe is used to mean the fact that an excess of the probe is added to the sample, and it only binds to the structures enabling individualising identification, such as RNA molecules (rRNA molecule), to which it is meant to bind. In the method, specifically advantageously, specific probes and fluorescent agents are used, such as e.g. fluorochromes, which are known several. Examples of probes are given e.g. in publication Phylogenetic identification and in situ detection of individual microbial cells without cultivation; R. I. Amann et al., Microbiological Reviews, 1995, vol. 59, p. 143-169, and examples of fluorochromes are given e.g. in publication Handbook of Fluorescent Probes and Research Products, Molecular Probes. The excess of the probe can be either washed from the sample or left in the sample, since the intensity of the fluorescence and scattering from it is not sufficiently high to interfere with the interpretation of the results.

The fluorescent agent is usually attached to the probe already prior to binding the probe to a structure, such as e.g. a rRNA molecule, enabling the individualising identification of the micro organism. The fluorochrome can be attached to the probe as early as in buying the probe, or it can be attached thereto prior to starting the treatment according to the method.

According to one embodiment of the invention, at step d) of the method, in the sample to be subjected to flow there are in addition also micro particles, which are distinguished by means of their scattering properties and/or fluorescence properties. In addition, in the method and device in accordance with the invention there is a possibility of using a feeding device portioning out a standard amount of sample, a flow meter or some other device known to a person skilled in the art by means of which it is possible to measure the amount of the analysed sample. In this way, it is possible to determine the concentration of the micro organisms and micro organism species to be analysed in the sample. To calculate the accurate number of the micro organism cells contained in the sample to be analysed, the concentration of micro organisms and the portion of the target micro organisms, it is thus possible to use e.g. fluorescing micro particles or a feeding device portioning out a standard amount of sample.

The number of pieces of the micro organisms can thus be determined using commercial sample tubes that contain a known number of micro particles (e.g. TruCount™, manufacturer Becton Dickinson). The micro particles can be dependably distinguished from the rest of the particles of a mixed bacterial sample based on their scattering and fluorescence properties. The sample tube contains a known amount of micro particles, and a known amount of the sample to be examined is portioned out into the sample tube. A part of the micro particles homogenously distributed into the sample is recognised. The portion of the identified micro particles from all the micro particles in the tube is directly proportional to the portion of the micro organisms identified at the same time from all the micro organisms in the sample. Thus, this enables one to easily calculate the concentration of the micro organisms in the sample. Another alternative for calculating the number of the micro organisms contained in the sample is to use a feeding device that portions out a standard amount of sample (e.g. Particle Analysing System PAS, Partec). The feeding device portions out a known volume of the sample. The portion of the dosed volume from the total volume of the sample is directly proportional to the portion of the identified micro organisms from the total number of micro organisms in the sample.

When using the aforementioned micro particles, which thus differ in respect of their scattering and/or fluorescence properties from the particles of the sample, these micro particles can be added to the sample as treated in accordance with steps a)-c) or vice versa. In the same manner, it is also possible to add the aforementioned particles to the sample at any step prior to step d) i.e. subjecting the sample to flow, e.g. prior to feeding into the flow cytometer. Particularly advantageously, ready-made sample tubes are used in which there is a predetermined number of micro particles. Tubes of this kind are produced e.g. by the company Becton Dickinson.

The aforementioned monochromatic lights disposed in the first and second wavelength area can be produced by one, two, three or more light sources. In case the aforementioned lights are produced by more than just one light source, these light sources can be disposed in such a manner that the beams of light produced by them are directed at one, two or more points in the device. In case the light sources are directed at more than just one point, one uses in the method preferably signal delay equipment in order to delay the measuring signals produced by the first and optionally by the subsequent light sources.

According to one embodiment of the invention, the first wavelength area is 600-650 nm, and the second wavelength area is 350-600 nm. The aforementioned first and second wavelength area are preferably different wavelength areas; substantial is the fact that the condition “the fluorescent agents and the wavelength areas of the monochromatic light are chosen in such a manner that between the fluorescences of the fluorescent agents, a measurable difference in intensities is achieved” is fulfilled in order that dependable results can be obtained. In case the light sources are directed at more than just one point, the wavelengths of the wavelength area of the beam of light first encountered by the sample can be higher or lower than the wavelengths of the wavelength area secondly encountered by the sample. In case the fluorescent agents used, e.g. fluorochromes, have considerably different fluorescent properties, the wavelengths can be also similar. A considerable difference is herein used to mean a difference by means which the aforementioned condition is fulfilled. The aforementioned difference can be e.g. double on a logarithmic scale, and advantageously quadruple on a logarithmic scale. It is obvious to a person skilled in the art that a couple of fast tests make it possible to find out what wavelength shall be used.

Hereinafter, in an experimental part, an example of the selection of the wavelength area has been given.

According to one specific embodiment of the invention the light sources have been chosen from a group consisting of a diode laser of 635 nm and an argon ion laser of 488 nm.

According to one embodiment of the invention, the sample to be examined is a sample originating from the digestive system of a mammal. This kind of sample may be e.g. human or animal faeces. According to another embodiment of the invention, the sample to be examined is a waste water sample. Furthermore, the method and device in accordance with the invention enable one to examine micro organism samples which are solid in respect of their original composition but which have been suspended into liquid for the analysis.

The method in accordance with an advantageous embodiment of the invention is based on the simultaneous use of two lasers of different wavelengths, disposed successively with respect to the direction of flow of the sample flow being analysed and of the fluorescent agents such as fluorochromes suitable for them. One of the lasers is a laser of the red wavelength area (600-650 nm), and the other one is a laser of the orange or a shorter wavelength area (450-600 nm). One of the fluorescent agents such as fluorochromes used in the method is attached to the hybridisation probe and the other one is a DNA colour. The absorbance spectrum of the fluorochrome used in the hybridisation probe is suitable for a laser of a longer wavelength, and the absorbance spectrum of the DNA colour is correspondingly suitable for a laser of a shorter wavelength. To distinguish the micro organism of the species to be examined, the fluorochromes of the probes hybridised into the nucleic acids of the target micro organisms are excited with the laser of the red wavelength area. To distinguish the particles containing DNA from particles not containing DNA, the DNA colour bound to the particles in the sample containing DNA is excited with the laser of the orange or a shorter wavelength area.

The exact number of micro organism cells contained in the sample and the portion of the target micro organisms from all the micro organisms is calculated using fluorescent micro particles homogeneously suspended into the sample. The functionality of the method has been tested by calculating the number of bacteria of the genus Bifidobacterium in human faecal samples and by calculating from the same analysis the total number of bacteria in human faeces, as well as the portion of the bacteria of the genus Bifidobacterium from all the bacteria contained in faecal samples, as it has been hereinafter shown in the experimental part. As the comparison method, the only analysis method of mixed bacterial samples widely used, i.e. the microscopy-FISH, has been used. The laborious microscopy-FISH was performed exercising specific caution and accuracy. The methods give identical results, which proves the functionality of the method according to the invention presented above. The example shown herein is thus an example of the method in accordance with the invention.

Furthermore, the invention relates to the use of this method and device for identifying micro organisms, e.g. bacterial strains, and for measuring their portions. According to one embodiment of the invention, the aforementioned micro organism is a probiotic bacterial strain. It is obvious to a person skilled in the art that the invention in accordance with the invention can be used to identify any other micro organism strain, required that for the micro organism strain to be identified, probes and fluorescent agents such as fluorochromes suitable for the method can be obtained. The method in accordance with the invention can be used to examine e.g. prebiotes.

Industrial and scientific applicability the invention has thus e.g. in foodstuff and fodder industry as well as in medicinal diagnostics. In medicinal diagnostics, using the method one does not, however, directly obtain such a result based on which it would be possible to diagnose a disease, instead for the interpretation of the results, a person acquainted with medicine is needed. The manufactures of functional foodstuffs need a dependable and fast analysis method of mixed bacterial samples, in order that it would be possible to state the possible effect of foodstuffs on the bacterial strains and their fixed amounts in the intestines. The fodder industry endeavours to counter salmonella infections of e.g. poultry by developing such fodders that would favour the growth of non-malignant bacteria in the intestines of animals. This would reduce the need for the use of antibiotics in animal breeding and reduce the creation of bacterial species resistant to antibiotics. There is an increasing demand for novel species-specific analysis and calculation methods of mixed bacterial samples in medicinal research and clinical diagnostics.

The human intestinal flora is known to contain more bacterial cells than there are eukaryotic cells of one's own in a human being, so the interaction between the microbes and the host organism is wide-ranging and largely unknown (Human fecal flora: the normal flora of 20 Japanese-Hawaiians; W. E. C. Moore and L. V. Holdeman, Applied Microbiology, 1974, vol. 27, pp. 961-979). The microbial colonisations of the organism have been believed to be the reason for several diseases still unknown as their aetiology is concerned. Examples of diseases of this kind include allergies and rheumatoid arthritis; R. Peltonen, doctoral thesis, 1994, University of Turku, and the Role of gut microflora in the hygiene hypothesis of allergy; M. Kalliomäki, doctoral thesis, 2001, University of Turku).

In the following section, the invention will be described in more detail with reference to the accompanying drawing.

### DESCRIPTION OF THE DRAWING

The drawing consists of the following figures:

FIG. 1 schematically represents a flow cytometer in accordance with the invention used in the method in accordance with the invention.

FIG. 2 is a schematic, cross-sectional view of the flow cytometer shown in FIG. 1.

FIGS. 3a, 3b and 3c schematically illustrate the principle of signal formation in the method in accordance with the invention.

FIG. 4 schematically represents the operational principle of the signal delay equipment.

FIG. 5 shows the results of the example.

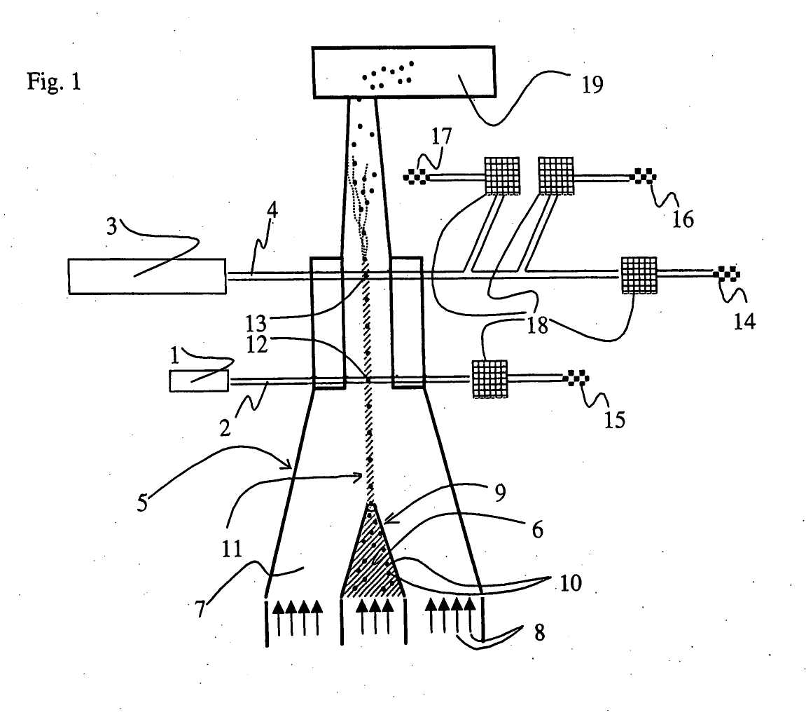

FIG. 1 schematically represents the device in accordance with the invention, which in this example is a flow cytometer. In FIG. 1 there is shown a laser 1 and a laser beam 2 coming from it. Furthermore there is shown in the figure a laser 3, the wavelength of the laser beam 4 coming from which is shorter than the wavelength of the laser beam 2. Furthermore, it is possible to use a feeding device that enables the dosing of a standard amount of sample. Further, in the figure there is shown a flow chamber 5, in which the sample solution 6 and the shell fluid 7 surrounding it flow into the direction shown by arrows 8. The sample solution 6 is fed into the shell fluid 7 by means of a sample feeding needle 9. In the sample solution 6 there are particles 10 being analysed, which can be e.g. a hybridised and DNA stained micro organism, e.g. a bacterium, a non-hybridised DNA stained micro organism, e.g. a bacterium, a DNA non-stained particle not containing DNA, or a micro particle utilised in the calculation of the number of micro organisms. The sample solution 6 flows through the laser beams 2 and 4 as being so narrow that the particles contained in it form a line of particles 11. The intersection points of the line of particles 11 and of the laser beams 2 and 4 are marked with reference numerals 12 and 13, respectively.

In the device there is further a photo diode 14, functioning as the FSC detector, a photo multiplier tube 15, functioning as the FL2 detector, and a photo multiplier tube 17, functioning as the SSC detector. Furthermore, there are in the device optical filters and mirrors 18 included in the optical system of a flow cytometer, by means of which the fluorescent light of a certain wavelength, scattered from the particles is filtered and directed to the detectors 14, 15, 16 and 17. There may also be a waste container 19 in the device, into which the sample is introduced after the analysis. For the sake of simplification of the figures, the FL1 and FL3 detectors are not shown herein. Furthermore, the device may comprise calculation means for calculating the portions of the identified micro organisms from the total amount of sample.

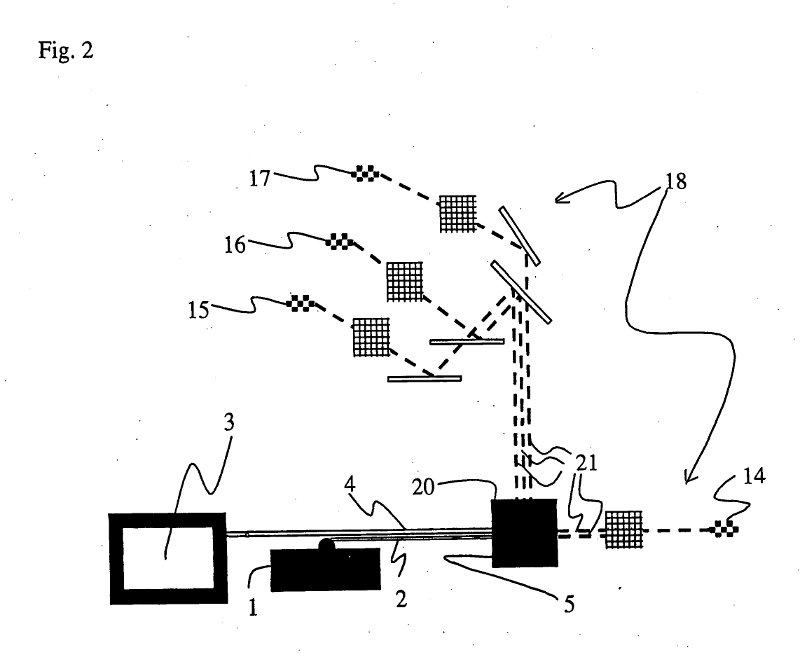

FIG. 2 shows a cross-sectional view of the same equipment as shown in FIG. 1. In the figure, by reference numeral 20 there is shown a particle disposed at the intersection point of the laser beam and the sample solution, which particle scatters and fluoresces light. The scattered and fluoresced light has been schematically shown by lines 21.

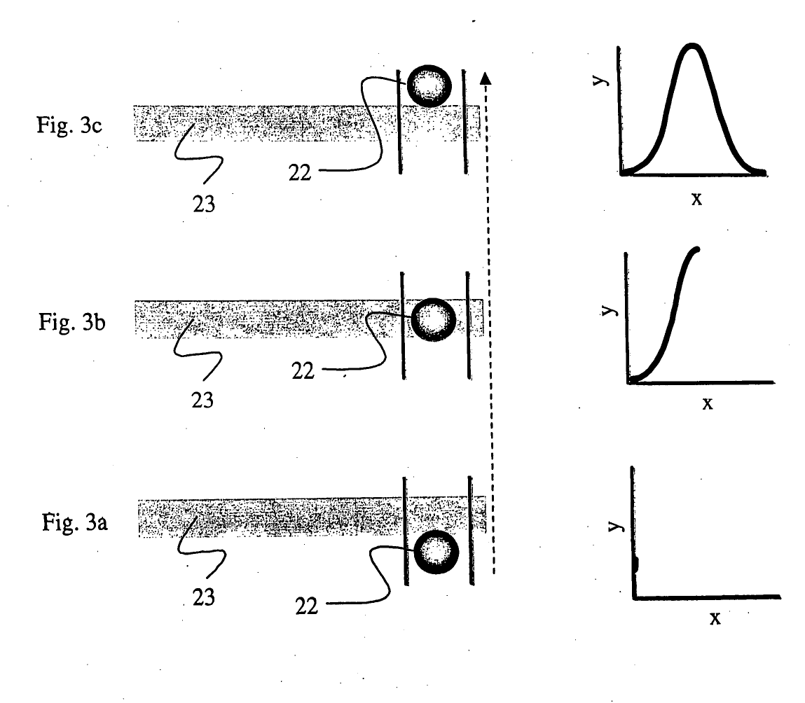

FIGS. 3a, 3b and 3c show the principle of signal formation. In FIG. 3a there is shown step 1, at which a particle 22 travels along with the fluid flow proceeding from downward to upward to meet a laser beam 23. The laser beam 23 scatters from the particle 22, and the fluorochromes are excited and emit light according to their emission spectra. The photo diode and photo multiplier tubes of the flow cytometer as well as the rest of the electronics of a flow cytometer change the optical signals into analogous voltage pulses, as has been described in co-ordinates in which on x axis there is shown the time and on y axis the voltage. The peak voltage of the voltage pulses is achieved at step 2, which is shown in FIG. 3b, when the particle is totally inside the laser beam 23. The scattering of the laser beam 23 and the number of emitting fluorochromes are at their biggest at that moment. At step 3 presented in FIG. 3c, as the particle 22 leaves the laser beam 23, the voltage starts to correspondingly decrease. The time consumed for the formation of the voltage pulse depends on the size and flow velocity of the particle 22, and is in practice some micro seconds.

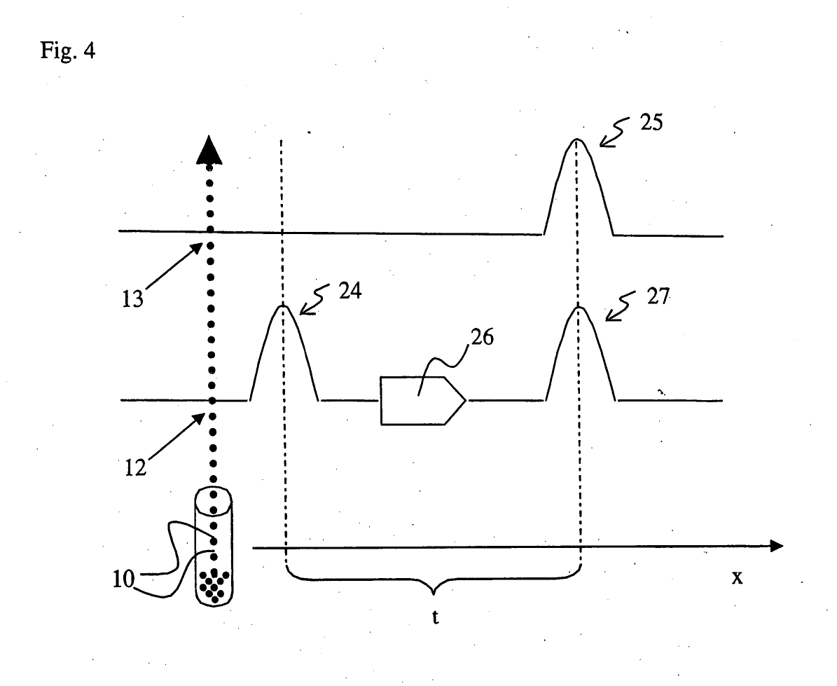

FIG. 4 schematically shows the principle of signal delay in the device using two devices in accordance with the invention. The figure shows particles 10, which form the line of particles of the sample solution, as well as the intersection point 13 of the first laser beam and of the line of particles, as in FIG. 1. Further, on the x axis there are shown the voltage pulses. The first voltage pulse, which is created as the particle 10 meets the first laser i.e. the one with the longer wavelength at the intersection point 12 of the beam, is designated by reference numeral 24. In the example, the fluorescence caused by the laser with the longer wavelength in the particle 10 is detected by the FL4 detector, i.e. the voltage pulse 24 is created by the FL4 photo multiplier tube.

Reference numeral 25 shows a voltage pulse that is created as the particle 10 at a later point meets the second laser i.e. the one with the shorter wavelength at the intersection point 13 of the laser. In the example, the fluorescence caused by the laser with the shorter wavelength in the particle 10 is detected by the FL2 detector, the scattering of the laser beam at low angles by the FSC detector and the scattering of the laser beam at greater angles by the SSC detector. The time t between the creation of the first and second voltage pulse shown on the X axis is the time that it takes the particle 10 to travel the distance between the first and the second laser. In order that the measuring signals created by the particle 10 at different times and in different states would be identified as being originated from the same particle, the first voltage pulse must be delayed a time t in the circuit 26. The delayed voltage pulse is designated by reference numeral 27. The fluorescence and scattering signals created by the lasers in the same particle 10 at different points of time using the signal delay are synchronised into the same point of time, in order that the parameters obtained from the same particle 10 by the lasers would be described as being originated from the same particle 10.

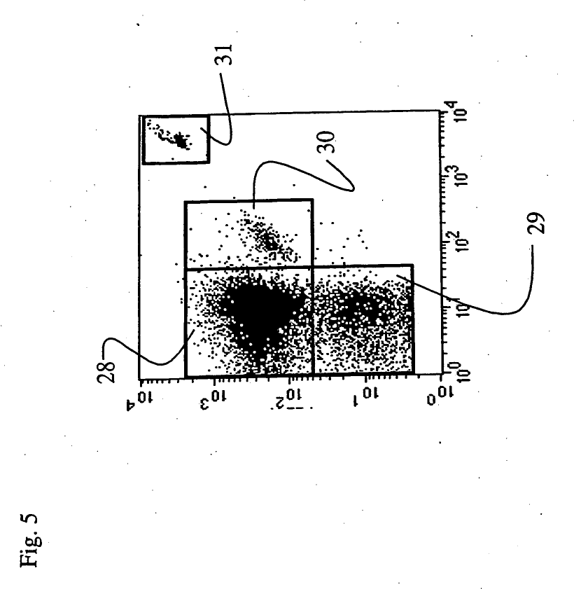

FIG. 5 shows the dot diagram, obtained by the flow cytometer analysis, of a faecal sample hybridised using the 16S rRNA technique, DNA stained and homogenised into a sample tube containing micro particles. Each dot in the diagram corresponds to one measured particle. The logarithmic scale of the X axis is used to measure the relative intensity (on channel FL4) of the fluorescence of the fluorochromes attached to the probe, and the y axis is used to measure the relative intensity (on channel FL2) of the fluorescence of the DNA colour. The x axis of the diagram shows the height of the voltage pulse (FL4 H, in which H stands for height), and in the same manner, the y axis shows the height of the voltage pulse. The diagrams could also be used to show the width or area of the voltage pulse. It is possible to distinguish four different populations in the dot diagram:
1. particles containing just the DNA colour, i.e. the bacteria of the sample other than the target bacteria, designated by reference numeral 28,
2. particles weakly fluorescing on both of the fluorescence parameters, i.e. the background population, designated by reference numeral 29,
3. particles containing both the probe and the DNA colour, i.e. the target bacteria, designated by reference numeral 30, and
4. micro particles strongly shown on both fluorescence channels, designated by reference numeral 31.

Populations 1. and 3. together form the total population of bacteria in the sample. In a faeces sample, the background population is mainly composed of fibrous materials undigested in the digestive tract. In the example it is explained in more detail how the diagram has been achieved.

### EXPERIMENTAL PART

### Example

The method and device in accordance with the invention were used to examine the bacteria contained in human faecal samples by hybridising them using the 16S rRNA technique and the DNA staining (as is disclosed in publication Quantitative fluorescence in situ hybridization of Bifidobacterium spp. with genus-specific 16S rRNA targeted probes and its application in fecal samples; P. S. Langendijk et al., Applied and Environmental Microbiology, 1995, vol. 61, p. 3069-3075). As the probe, a bifidobacterium-specific probe was used that had been labelled with the Cy5 label (manufacturer Eurogentec) of the red wavelength area, which Cy5 label has an absorption maximum of about 643 nm and an emission maximum of about 667 nm and which can thus be identified by the FL4 detector. As the DNA colour, the SYTOX™ Orange colour of the orange wavelength area was used, the absorption maximum of which is about 547 nm and the emission maximum about 570 nm and which was identified by the FL2 detector. The absorption maximum of the SYTOX™ Orange is wide enough to be excited by the laser light of 488 nm. The hybridised faecal sample was homogenised into a sample tube (manufacturer the company Becton Dickinson) containing TruCount™ micro particles. As being carried along by the fluid flow, the hybridised bifidobacterium of the sample reached the intersection point of the optically focused beam of the red diode laser having the wavelength of 635 nm and that of the hydro dynamically focused line of particles The Cy5 fluorochromes in the probes hybridised into the bacterium absorb energy from the laser beam and fluoresce i.e. emit the energy absorbed by them as a light having a longer wavelength than their exciting wavelength, which light was identified by the FL4 photo multiplier tube, and a voltage pulse started to be created, as is shown in FIG. 3a. As the bacterium is only partly disposed in the beam of the first laser, just a small fraction of the probe's fluorochromes contained in the bacterium absorbs energy and emits light, so the voltage pulse by the FL4 photo multiplier tube had not yet reached its peak. The effect of exciting flurochromes of the laser beam was at its maximum as the particle was disposed in the centre of the intersection point of the beam's point of focus, allowing the voltage pulse to reach its peak value (as is shown in FIG. 3b). As the bacterium leaves the laser beam, the number of fluorochromes attached to the probes and absorbing energy and emitting light decreased, so the voltage pulse decreased (FIG. 3c). The voltage pulse being created was delayed in the circuit for 22±1 micro seconds. During the delay, the bacterium reached the intersection point of the beam of an argon ion laser having the wavelength of 488 nm and that of the line of particles. The light of 488 nm of the laser excited the bacterium's DNA colour bound to DNA, and the light fluoresced by the DNA colour and having a longer wavelength than its exciting wavelength fluoresced was identified by the FL2 photo multiplier-tube. In this way, a second voltage pulse was created. Two threshold values were used in the method in order to make sure that the particles to be classified as bacteria really were bacteria. To ensure a sufficient scope of the sample, the threshold value of the SSC parameter was set so as to be so low that all the bacteria would be identified. However, in the sample there were also particles other than bacteria, the SSC signal of which exceeded the threshold value. To solve this problem, a second threshold value was used that was set for the FL2 channel, i.e. for the channel identifying the DNA colour. Prior to being measured, the particles exceeding the SSC threshold value had to exceed also the FL2 value, so by using two threshold values, the bacteria could be dependably distinguished from the rest of the particles contained in the sample. The voltage pulses were amplified by a logarithmic amplifier, digitised and analysed by the aid of a computer connected to the flow cytometer. The maximum height of the voltage pulse is proportional to the intensity of the fluorescence of the fluorochromes contained in the bacterium. The measuring signals caused by the bacterium on the FL2 and FL4 channels were processed by a computer and described in a dot diagram (FIG. 5). The bacterium being a bifidobacterium hybridised in a manner as described above, it was described as being included in the target bacterial population (reference numeral 30 in FIG. 5). In case the bacterium was some non-hybridised bacterium, it was described as being included in the population of the rest of the bacteria contained in the sample (reference numeral 28 in FIG. 5). The DNA non-stained particles were described as being included in the background population (reference numeral 29 in FIG. 5), and the fluorescent micro particles used to count the exact number of bacterial cells formed a population of their own (reference numeral 31 in FIG. 5)

Table 1 shows the results of the analyses of three faecal samples collected at intervals of three weeks from five volunteer testees. The faecal samples were treated according to a generally known attachment method and hybridised with a bifidobacterium-specific probe as well as DNA stained (as is disclosed in publication Quantitative fluorescence in situ hybridization of Bifidobacterium spp. with genus-specific 16S rRNA-targeted probes and its application in fecal samples; P. S. Langendijk et al., Applied and Environmental Microbiology, 1995, vol. 61, p. 3069-3075). The total number of bacteria contained in the sample and the number and portion in percentages of hybridised bifidobacteria from all the bacteria contained in the sample have been calculated both by the flow cytometry in accordance with the invention and by the fluorescence microscopy. The flow cytometric analysis was performed using the method in accordance with the invention, and the fluorescence microscopic analysis was performed according to Langendijk's publication. As can be seen from Table 1, the methods give very similar results as concerns both the portion of the bifidobacteria and the total number of bacteria. In the calculation performed by the flow cytometer, about 20000 bacteria were counted from each sample, and the analysis time of one sample is about half a minute. In the calculation performed by the fluorescence microscopy, about 2000 bacteria per sample were counted, and the analysing of one sample took about one hour.

TABLE 1

| | | | | Portion of | |
|---|---|---|---|---|---|
| | | Bacteria (10¹⁰/g) | | bifidobacteria | |
| | Time | | Flow | | Flow |
| Testee | (weeks) | Microscopy | cytometry | Microscopy | cytometry |
| I | 0 | 2.3 | 2.1 | 2.2% | 2.3% |
| | 1 | 2.9 | 2.2 | 3.7% | 3.5% |
| | 2 | 3.0 | 3.1 | 1.4% | 0.9% |
| II | 0 | 1.0 | 1.1 | 6.9% | 7.8% |
| | 1 | 1.2 | 1.5 | 4.5% | 4.3% |
| | 2 | 1.8 | 1.5 | 4.5% | 3.9% |
| III | 0 | 2.0 | 2.1 | 0.31% | 0.0% |
| | 1 | 2.8 | 2.2 | 0.63% | 0.0% |
| | 2 | 2.7 | 2.5 | 0.59% | 0.0% |
| IV | 0 | 2.8 | 2.7 | 1.7% | 1.3% |
| | 1 | 2.0 | 2.6 | 3.5% | 3.0% |
| | 2 | 3.2 | 2.4 | 2.9% | 2.3% |
| V | 0 | 2.3 | 3.1 | 6.1% | 5.9% |
| | 1 | 3.3 | 2.9 | 7.4% | 8.0% |
| | 2 | 2.6 | 2.8 | 5.5% | 6.0% |

1-36. (canceled)

37. A method for identifying one or more micro-organism and/or micro-organism species, and for measuring the portion of at least one micro-organism and/or micro-organism species from a sample, characterized in that
a) binding to a structure individualizing at least one micro-organism species or group and enabling identification a first fluorescent agent that absorbs light in a first wavelength area,
b) binding to a structure characteristic of all micro organisms a second fluorescent agent that absorbs light in a second wavelength area,
c) subjecting the sample to flow,
d) exciting the aforementioned first fluorescent agent in the aforementioned flow with a monochromatic light disposed in the first wavelength area,
e) exciting the aforementioned second fluorescent agent in the aforementioned flow with a monochromatic light disposed in the second wavelength area,
f) identifying the target micro-oraganism by analyzing the fluorescence of the fluorescent agents bound to the particles of the sample,
and in that the fluorescent agents and the wavelength areas of the monochromatic light are chosen in such a manner that the difference in intensities of the mean fluorescences of the fluorescent agents is at least about double on a logarithmic scale.

38. The method according to claim 37, characterised in that the method further comprises a step at which the portion(s) of the identified target micro-organism(s) is/are calculated from the total amount of sample.

39. The method according to claim 37, characterised in that a measurable difference in intensities between the fluorescences of the fluorescent agents is achieved in the first wavelength area.

40. The method according to of claim 37, characterised in that the sample is introduced into a flow cytometer.

41. The method according to claim 37, characterised in that a first fluorescent agent is attached to the probes that are bound to the structure individualizing at least one micro-organism species or group in the sample and enabling the identification.

42. The method according to claim 37, characterised in that a structure individualizing one micro-organism species or group and enabling the identification is a ribosomal RNA molecule.

43. The method according to claim 37, characterised in that a structure characteristic of all micro-organisms is DNA.

44. The method according to claim 37, characterised in that a threshold value is set for each micro-organism for each parameter specifically, and the micro-organisms are classified based on their threshold values.

45. The method according to claim 37, characterised in that the fluorescent agent is a fluorochrome.

46. The method according to claim 37, characterised in that the micro-organism is a bacterium and/or a bacterial species.

47. The method according to claim 46, characterised in that the aforementioned ribosomal RNA molecules are chosen from a group consisting of 16S ribosomal RNA molecules and 23S ribosomal RNA molecules.

48. The method according to claim 37, characterised in that the light scattering from the particles of the sample is detected.

49. The method according to claim 37, characterised in that micro particles are further separated from the sample based on their scattering and/or fluorescence properties.

50. The method according to claim 37, characterised in that the first wavelength area is 600-650 nm.

51. The method according to claim 37, characterised in that the second wavelength area is 350-600 nm.

52. The method according to claim 37, characterised in that the monochromatic lights disposed in the first and second wavelength area are formed by one light source.

53. The method according to claim 37, characterised in that the monochromatic lights disposed in the aforementioned first and second wavelength area are formed by at least two light sources.

54. The method according to claim 53, characterised in that at least two of the aforementioned at least two light sources are disposed at a distance from each other, and in that in the method, signal delay equipment is used to delay the measuring signals being created by means of the first and optionally the subsequent light sources.

55. The method according to claim 37, characterised in that the sample is a sample from a mammal's organism fluid.

56. The method according to claim 55, characterised in that the sample is a sample originating from a mammal's digestive system.

57. The method according to claim 37, characterised in that the sample is a waste water sample.

58. A device for identifying one or more micro-organisms and/or micro-organism species and for measuring the portion of at least one micro-organism and/or micro-organism species from the sample, characterised in that the device comprises:
a) a flow chamber (5), into which a solution being analysed (6) containing the sample is introduced, in which to a structure individualizing at least one micro-organism species or group and enabling the identification, a first fluorescent agent is bound that absorbs light in a first wavelength area, and in which to a structure characteristic of all micro-organisms, a second fluorescent agent is bound that absorbs light in a second wavelength area,
b) a light source (1, 3) for producing a monochromatic light at different wavelengths,
c) one or more detectors (14, 15, 16, 17) for measuring the signal forming the fluorescent agent for identifying the target micro-organism,
and in which device the fluorescent agents of the sample and the wavelength areas of the monochromatic light are chosen in such a manner that the difference in intensities between the mean fluorescences of the fluorescent agents is at least double on a logarithmic scale.

59. The device according to claim 58, characterised in that the device further comprises calculation means for calculating the portion(s) of the identified micro-organism(s) from the total amount of sample.

60. The device according to claim 58, characterised in that a measurable difference in intensities between the fluorescences of the fluorescent agents is achieved in the first wavelength area.

61. The device according to claim 58, characterised in that the device is a flow cytometer.

62. The device according to claim 58, characterised in that the detector (14, 15, 16, 17) is used to detect the light scattering from the particles in the sample.

63. The device according to claim 58, characterised in that the device further comprises a feeding device for dosing a standard amount of sample.

64. The device according to claim 58, characterised in that the light source (1, 3) includes at least two light sources for producing the aforementioned monochromatic lights disposed in the first and second wavelength area.

65. The device according to claim 64, characterised in that at least two of the aforementioned at least two light sources are disposed at a distance from each other, and in that the device further comprises signal delay equipment for delaying the measuring signals being created by means of the first and optionally the subsequent light sources.

66. The device according to claim 58, characterised in that the aforementioned light source(s) (1, 3) is/are chosen from a group consisting of a diode laser of 635 nm and an argon ion laser of 488 nm.

67. The use of a method according to claim 37 for identifying micro-organisms and for measuring their portions.

68. The use according to claim 67, characterised in that the micro-organism is a probiotic bacterial strain.

69. The use of a device according to claim 58 for identifying micro-organisms and for measuring their portions.

70. The use according to claim 69, characterised in that the micro-organism is a probiotic bacterial strain.
